(19) United States
(12) Patent Application Publication
(10) Pub. No.: US 2018/0357880 A1
(43) Pub. Date: Dec. 13, 2018

(54) BUILDING MANAGEMENT USING LOCATION INFORMATION

(71) Applicant: Honeywell International Inc., Morris Plains, NJ (US)

(72) Inventors: Arun Vijayakumari Mahasenan, Hopkins, MN (US); Himanshu Khurana, Plymouth, MN (US); Amit Kulkarni, Plymouth, MN (US); Jagmeet Singh Puri, Edina, MN (US)

(21) Appl. No.: 15/843,958

(22) Filed: Dec. 15, 2017

Related U.S. Application Data
(60) Provisional application No. 62/517,675, filed on Jun. 9, 2017.

(51) Int. Cl. G08B 21/18; G08B 7/06; G08B 17/00; G05B 15/02

(52) U.S. Cl. CPC G08B 21/18; G05B 15/02; G08B 17/00; G08B 7/066

(57) ABSTRACT

Devices, Systems, and methods for building management using location information are described herein. One device includes instructions stored thereon executable by a processor to track a location of a mobile device in a building, trigger an alert responsive to a determination that the tracked location of the mobile device exceeds a threshold correlation to a predetermined location rule, and modify an operation of a building system associated with the building according to the location rule and responsive to the alert.

### PRIORITY INFORMATION

This application claims the benefit of U.S. Provisional Application No. 62/517,675, filed Jun. 9, 2017, the contents of which are incorporated herein by reference.

### TECHNICAL FIELD

The present disclosure relates to devices, systems, and methods for building management using location information.

### BACKGROUND

A Building Management System (BMS) can allow the control and/or monitoring of systems in one or more buildings. For instance, a BMS can control security systems, lighting systems, heating, ventilation, and air conditioning (HVAC) systems, fire systems, and/or access control systems, among others.

Previous approaches to BMSs may not fully leverage information about where people and/or things are actually located within a building at a given point in time. Because of this shortcoming, previous approaches may fall short in the areas of safety and security, energy efficiency, and/or comfort control, for instance.

### BRIEF DESCRIPTION OF THE DRAWINGS

FIG. 1A illustrates a system for building management using location information wherein a mobile device is located at a first location in accordance with one or more embodiments of the present disclosure.

FIG. 1B illustrates the system for building management using location information wherein the mobile device is located at a second location in accordance with one or more embodiments of the present disclosure.

FIG. 2 illustrates a computing device in accordance with one or more embodiments of the present disclosure.

FIG. 3 illustrates a flow chart associated with building management using location information in accordance with one or more embodiments of the present disclosure.

### DETAILED DESCRIPTION

Building management using location information is described herein. For example, one or more embodiments include a computer-readable medium having instructions stored thereon executable by a processor to track a location of a mobile device in a building, trigger an alert responsive to a determination that the tracked location of the mobile device exceeds a threshold correlation to a predetermined location rule, and modify an operation of a building system associated with the building according to the location rule and responsive to the alert.

Embodiments of the present disclosure can enhance the operation of building systems by leveraging information about the locations, in the building, of people and/or assets. Increased levels of comfort can be provided while energy savings are realized. Additionally, embodiments herein can provide enhanced safety and security though the use of real-time location information.

Embodiments of the present disclosure include the tracking, over time, of locations of mobile devices. In some embodiments, people in a building can be tracked via their smart phones and/or wearable devices. In some embodiments, hardware devices (hereinafter referred to as “tags”) can be associated with (e.g., attached to) building assets, which can then be tracked throughout the building. Such assets may include physical and/or tangible objects, such as devices, equipment, components, tools, and/or conveyances (e.g., vehicles, hospital beds, etc.), among other assets.

Embodiments herein can allow for the creation and/or modification of location rules. A location rule can define a location, pattern, or interaction of one or more mobile devices that triggers an alert. In some embodiments, an alert can be referred to as an “event.” An alert can be sent and/or published to a subscribing device (e.g., to a computing device, described below). Alerts can cause a building management system (BMS) to modify an operation of one or more systems of the building (hereinafter referred to as “building systems”). The location rule can define what operations are modified as a result of the alert. In some embodiments, location rules can be particular to individuals and/or individual assets. In some embodiments, location rules can be more general and/or widely applicable.

For example, if a person crosses a geofence or enters a particular room, an alert can be triggered causing a security camera to be focused on that person in accordance with a rule. If a hospital gurney has been in use in an emergency room for a particular period of time, an alert can be triggered that notifies maintenance personnel of the need to sanitize the gurney. If two prisoners, known to be co-conspirators, interact at a particular frequency or for a particular period of time, a security system can be notified to monitor and/or separate them.

In some embodiments, multiple systems can be affected. For example, if a person is approaching a room, the temperature can be adjusted according to their temperature preference, lighting in the room can be adjusted according to their lighting preference, and/or a relay associated with a door of that room can be actuated in order to allow entry into the room without the need for the person to present a card or token.

It is to be understood that BMSs can manage and/or control many different mechanical and/or electrical building systems. Embodiments of the present disclosure can enhance the operation of any or all of these systems through the use of real-time location information. These systems include, but are not limited to, fire systems, lighting systems, HVAC systems, access control systems, elevator systems, surveillance systems (e.g., closed-circuit television (CCTV) systems), security systems, and public address systems. As a result, embodiments of the present disclosure can increase safety and security, reduce energy consumption, and provide enhanced comfort.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. As used herein, “a” or “a number of” something can refer to one or more such things. For example, “a number of areas” can refer to one or more areas.

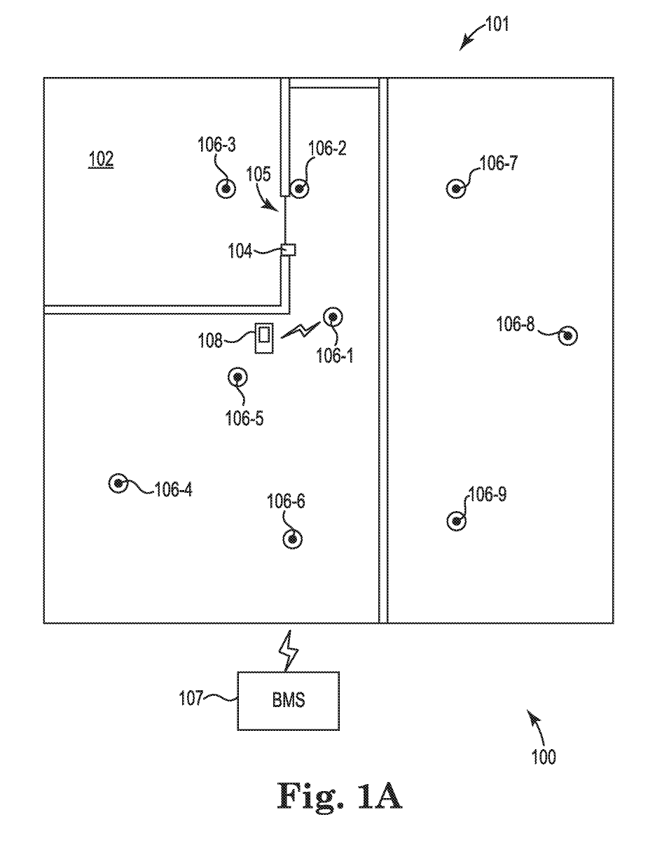

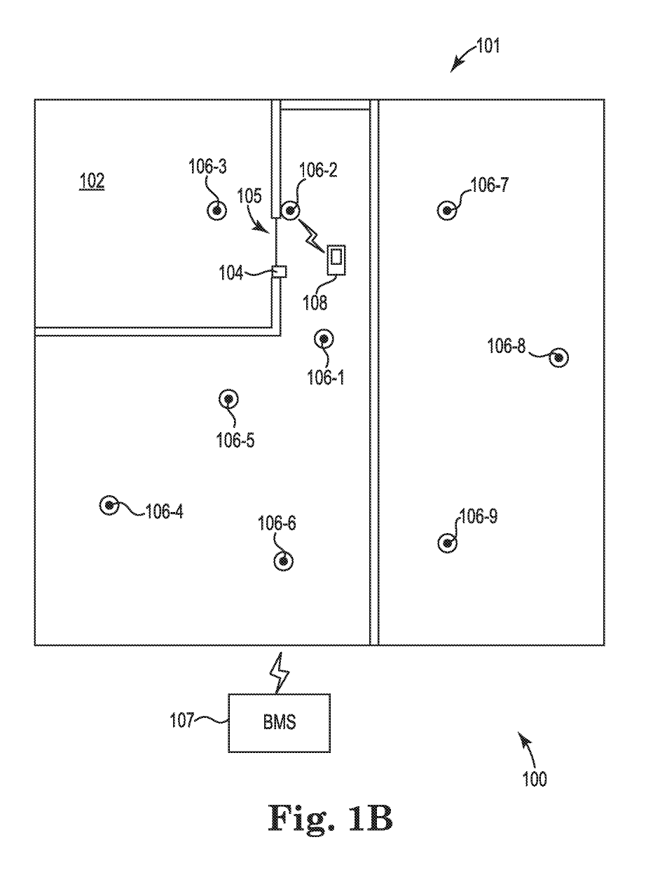

FIG. 1A illustrates a system 100 for building management using location information wherein a mobile device is located at a first location in accordance with one or more embodiments of the present disclosure. As shown in FIG. 1A, system 100 includes a plurality of beacons in a building 101. Nine beacons are illustrated in FIG. 1, though it is noted embodiments of the present disclosure are not limited to a particular number of beacons. The beacons include a beacon 106-1, a beacon 106-2, a beacon 106-3, a beacon 106-4, a beacon 106-5, a beacon 106-6, a beacon 106-7, a beacon 106-8, and a beacon 106-9, and are cumulatively referred to herein as “beacons 106.”

The beacons 106 are illustrated and discussed herein as an example system for determining a location of a mobile device 108; however, it is noted that embodiments herein are not so limited. Other methods of determining location are in accordance with the present disclosure. For example, such methods can include the use of global positioning systems (GPS), ultrasound systems, magnetic location systems, and/or visible light systems (e.g., using visible light communication (VLC)), among others.

The beacons 106 can be devices capable of wireless communication with the mobile device 108. In some embodiments, one or more of the beacons 106 can be associated with (e.g., located proximal to) a relay 104, a door 105, and/or an area (e.g., room) 102. For instance, the beacon 106-2 is located proximal to the door 105 (e.g., within 5 feet of the door 105). The beacons 106 can allow the determination of a location of the mobile device 108 in the building 101. For example, the beacons 106 can allow the determination of whether a mobile device is within a particular (e.g., threshold) distance of the area 102 and/or the door 105. The beacons 106 can communicate with the mobile device 108 via Bluetooth Low Energy (BLE) technology (e.g., as an iBeacon), WiFi, etc. In some embodiments, the beacons 106 can include one or more readable tags (e.g., near field communication (NFC)) tags.

“Building,” as used herein, can refer to one or more buildings, businesses, homes, plants, prisons, hospitals, refineries, etc. The building 101 can include indoor and/or outdoor areas. As shown in FIG. 1, the building 101 can include an area 102. The area 102 can be a portion of the building 101. In some embodiments, the area 102 can be a room, a plurality of rooms, a wing, a building, a plurality of buildings, an installation, etc. In some embodiments, the area 102 can be defined by physical boundaries (e.g., walls, doors, etc.). In some embodiments, the area 102 can be defined by logical and/or geographic boundaries. The area 102 can be defined by a user, by a Building Information Model (BIM) associated with the building 101, and/or by a building system (e.g., an access control system, security system, etc.).

The area 102 may be a restricted area and/or an area requiring access rights for entry. Entry into and/or exit from the area 102 can be made via a door 105. Unlocking of the door may be performed by a relay 104. The relay 104 can be a device allowing remote control that can be actuated by variation in conditions of one or more electric circuits. In some examples, the relay 104 can be a locking device. In some examples, the relay 104 can include one or more actuating mechanisms.

In some embodiments, control of the relay 104 may be provided from the mobile device 108. In some embodiments, the control may be provided directly from a computing device (e.g., the BMS 107, described below) or via one or more intermediary devices (e.g., a controller) in communication with the relay 104.

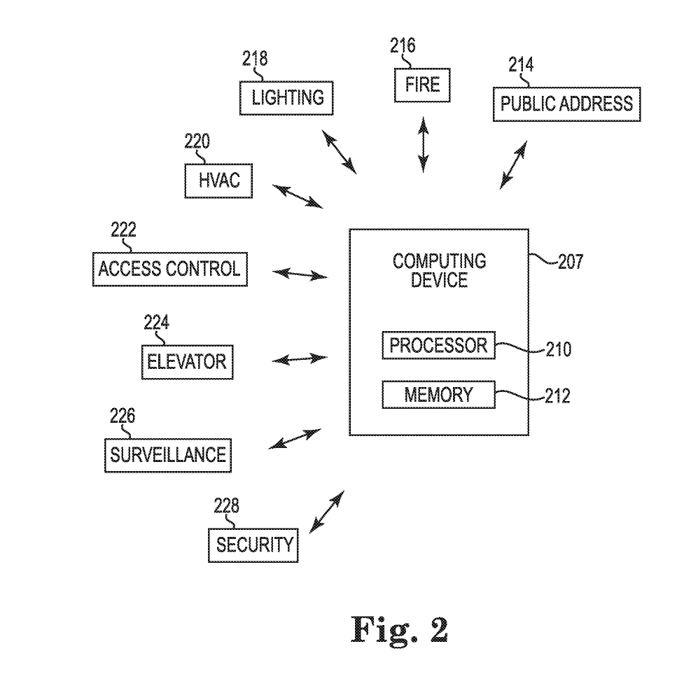

The BMS 107 can be a computing device (e.g., a computing device having a processor and a memory, described below in connection with FIG. 2). The BMS 107 can control (e.g., manage) a number of building systems of the building 101. Though in the example illustrated in FIG. 1 the BMS 107 is shown external to the building 101 (e.g., remote with respect to the building 101), embodiments of the present disclosure are not so limited. In some embodiments, the BMS 107 is internal to the building 101 (e.g., local with respect to the building 101). In some embodiments, the BMS 107 can be cloud-based. In some embodiments, the BMS 107 can manage system(s) across a plurality of buildings.

In some embodiments, the mobile device 108 can be a client device carried or worn by a user. For example, the mobile device 108 can be a phone (e.g., smart phone), personal digital assistant (PDA), tablet, and/or wearable device (e.g., wristband, watch, necklace, glasses, etc.). In some embodiments, the mobile device may not be carried or worn by a user. For example, the mobile device can be a tracking device (e.g., a tracking tag) and is herein referred to as a “tag.” Such a tag can communicate with the beacons 106.

The mobile device 108 can include one or more software applications (e.g., apps) which can define and/or control communications between the mobile device 108, the BMS 107, and/or other devices. Apps may be received by the mobile device 108 from the BMS 107, for instance. Apps may be launched by a user and/or responsive to some other condition (e.g., the interaction between the mobile device 108 and a beacon (discussed below)). In some embodiments, apps can be executing as background apps. Apps may be and/or include a digital identity, discussed further below.

The mobile device 102 can communicate with (e.g., exchange data with) the BMS 107 via a wired and/or wireless connection, for instance. In some embodiments, the mobile device 108 can communicate using one or more communications modules (e.g., cellular, WiFi, etc.). The BMS 107 can communicate with the relay 104 via a wired and/or wireless connection, for instance. Communication between various devices herein can be carried out over a wireless network. A wireless network, as used herein, can include WiFi, Bluetooth, or any other suitable means to wirelessly transmit and/or receive information.

In some embodiments, the mobile device 108 can include a location functionality configured to determine a location of the mobile device. In some embodiments, the location functionality includes a GPS and/or WiFi functionality of the mobile device 108, though embodiments of the present disclosure are not so limited. For example, the mobile device 108 can include an imaging functionality (e.g., a camera) which can be used to read a code at a particular (e.g., known) location in the building 101. In some embodiments, the mobile device 108 can utilize visual light communication (VLC) techniques to determine its position in the building 101.

Embodiments of the present disclosure can track a location of the mobile device 108 in the building 101. As discussed further below, the mobile device 108 can be associated with a particular user and/or asset. The user and/or asset can have access rights associated with the building 101. In some embodiments, the user and/or asset may have access to some portions of the building 101 but not other portions (e.g., the area 102). In some embodiments, tracking the location can include receiving location information by the BMS 107. The location information can be provided as a particular geographic location (e.g., latitude/longitude) and/or a location with respect to another location, such as an area of a building 101 or one or more of the beacons 106 of the building 101.

In some embodiments, location information can be communicated from the mobile device 108, and thus received by the BMS 107, responsive to a communication being established between the mobile device 108 and one or more of the beacons 106. In some embodiments, an indication that the mobile device 108 is within a particular distance of the area 102 can be received. By whatever manner the location of the mobile device 108 is determined and/or tracked, embodiments of the present disclosure can normalize and/or standardize the location information into a common format.

In some embodiments, tracking the location of the mobile device 108 can include determining a direction of travel and/or an intended destination of the user and/or asset with which the mobile device 108 is associated. FIG. 1B illustrates the system 100 for building management using location information wherein the mobile device 108 is located at a second location in accordance with one or more embodiments of the present disclosure. As shown, the second location is closer to the door 105 than the first location shown in FIG. 1A (the distance from the first location to the door exceeds the distance from the second location to the door). Subsequent to the first communication between the mobile device 108 and the first beacon 106-1, a communication established between the beacon 106-2 indicates that the user is approaching the door 105 with the intent to enter the area 102. Stated differently, the location of the mobile device 108 shown in FIG. 1B exceeds a threshold correlation with (e.g., matches) a location rule that triggers the operation of one or more building systems to be modified.

In an example, the operation of an access control system can be modified. For instance, If, based on the rule and the identity of the mobile device, the user and/or asset is determined to be allowed access to the area 102, the mobile device 108 and/or the BMS 107 can transmit a signal (e.g., a control signal) to the relay 104 associated with the area 102 to allow access. In some embodiments, the relay 104 can be responsible for physically locking the door 105 to the area 102 and the signal causes the relay 104 to change from a locked mode to an unlocked mode. Thus, the relay 104 can grant the user and/or asset access to the area 102 responsive to a determination by the mobile device 108 and/or the BMS 107 that the user is allowed access.

In some embodiments, additional systems may be modified based on this location information. For example, a thermostat (or temperature control device) associated with the area 102 can be adjusted according to temperature preferences of the user, and/or a lighting setting can be adjusted according to a lighting preference of the user. In some embodiments, security cameras in the room 102 can be activated. In some embodiments, a public address system that was deactivated while the room was unoccupied can be reactivated.

FIGS. 1A and 1B discuss examples where a predetermined location rule includes the tracked location being within a particular area 102 of the building 101 and/or within a particular distance of the area 102 of the building 101. Embodiments herein include additional location rules.

For example, a location having a threshold correlation to a location rule can include when a person or asset lingers in an area for a threshold-exceeding length of time (e.g., the tracked location is within a particular area of the building for a particular period of time). A location having a threshold correlation to a location rule can include two mobile devices having a threshold-exceeding proximity to one another (e.g., the tracked location being within a particular distance of another mobile device). A location having a threshold correlation to a location rule can include can include two mobile devices having a threshold-exceeding proximity to one another for a threshold-exceeding amount of time (e.g., the tracked location being within a particular distance of another mobile device for a particular period of time). Some rules can be determined by the BMS 107. Some rules may be user-created and/or user-configurable.

In some embodiments, rules may be applicable to a plurality of mobile devices. In some embodiments, rules may be applicable to a particular group or subset of mobile devices. In some embodiments, rules may be applicable to a single mobile device. It is also noted that rules can be time-sensitive; a rule may apply during a particular period of time (e.g., between 8:00 am and 5:00 pm) and not apply outside of that period.

As previously discussed, a location of the mobile device 108 that correlates to one or more location rules can cause the triggering of an alert to the BMS 107. Depending on what the rule dictates, different building systems can be affected responsive to the alert. For example, systems and/or personnel may be sent notifications (e.g., via carried devices and/or public address systems), devices may be deactivated (e.g., elevators and/or relays shut down), positions of devices may be modified (e.g., pan-tilt-zoom cameras may zoom in on the location of the mobile device), settings of devices may be modified (e.g., thermostats adjusted, fan speeds slowed, etc.). In some embodiments, the respective operations of multiple devices of a single building system may be modified. In some embodiments, the operations of one or more devices of a plurality of building systems may be modified.

In accordance with the present disclosure, operations of devices in building systems that provide safety and/or security (e.g., elevator systems, public address systems, security systems, surveillance systems, etc.) can be modified, operations of devices in building systems controllable to manage energy consumption (e.g., lighting systems, HVAC systems, etc.) can be modified, and operations of devices in building systems that provide personal comfort (e.g., lighting systems, HVAC systems, access control systems) can be modified. Such modifications can be made based on determinations such as, for example: where the mobile device is, how long the mobile device has been where it is, where the mobile device has been, how long it was there, where the mobile device is going, the speed at which it is traveling, and what interactions and/or relationship(s) with other mobile devices it has or has had.

FIG. 2 illustrates a computing device 207 in accordance with one or more embodiments of the present disclosure. The computing device 207 can be a portion of a BMS (e.g., analogous to the BMS 107, previously discussed). In some embodiments, the computing device 107 can be separate from the BMS and in communication with the BMS. The computing device 207 can include a memory 212 and a processor 210 configured to execute executable instructions stored in the memory 212 to perform various examples of the present disclosure, for example. That is, the memory 212 can be any type of non-transitory storage medium that can be accessed by the processor 210 to perform various examples of the present disclosure. For example, the memory 212 can be a non-transitory computer readable medium having computer readable instructions (e.g., computer program instructions) stored thereon that are executable by the processor 210.

The memory 212 can be volatile or nonvolatile memory. The memory 212 can also be removable (e.g., portable) memory, or non-removable (e.g., internal) memory. For example, the memory 212 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 212 is illustrated as being located within the computing device 107, embodiments of the present disclosure are not so limited. For example, memory 212 can also be located internal to another computing resource (e.g., enabling computer readable instructions to be downloaded over the Internet or another wired or wireless connection). In some embodiments, the memory 212 and/or the processor 210 can be located external to the BMS 107. The memory 212 can store the location rules discussed herein (e.g., predetermined location rules). Each location rule can be associated with one or more conditions that cause the triggering of an alert. For example, location rules can govern where people and/or assets are permitted and/or not permitted in a building, with what other people a person is permitted to interact (and for how long), how many people and/or assets are allowed in a particular area, which people are allowed to interact with which assets, and/or when a person and/or asset is in, or is traveling to, a particular location and/or area.

In addition to, or in place of, the execution of executable instructions, various examples of the present disclosure can be performed via one or more devices (e.g., one or more controllers) having logic. As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor. It is presumed that logic similarly executes instructions for purposes of the embodiments of the present disclosure.

The computing device 207 can be in communication with, and/or provide control of, a number of building systems. In the example illustrated in FIG. 2, for instance, the computing device 207 is shown as being in communication with a public address system 214, a fire system 216, a lighting system 218, an HVAC system 220, an access control system 222, an elevator system 224, a surveillance system 226, and a security system 228. The building systems shown in FIG. 2 are not to be taken in a limiting sense and are not intended to embody a complete listing of the building systems managed by a BMS, and/or in communication with the computing device 207.

Each of the building systems can include a plurality of devices and/or components, the operations of which can be modified in accordance with the embodiments herein. For example, the public address system 214 can include, for example, one or more computing devices, controllers, speakers, displays, and/or alarms. The fire system 216 can include one or more computing devices, controllers, speakers, alarms, sprinklers, smoke detectors, and/or temperature sensors. The lighting system 218 can include one or more computing devices, controllers, displays, lights, light emitting diodes (LEDs), blinds, and/or shades. The HVAC system 220 can include one or more computing devices, controllers, thermostats, variable air volume (VAV) devices, air handling units, humidifiers, dehumidifiers, fans, fan coil units, heat exchangers, compressors, and/or evaporators. The access control system 222 can include one or more computing devices, controllers, relays, locks, occupancy detectors, beacons, and/or card readers. The elevator system 224 can include one or more computing devices, controllers, motors, displays, and/or door actuators. The surveillance system 226 can include one or more computing devices, controllers, cameras, video cameras, and/or card readers. The security system 228 can include one or more computing devices, controllers, cameras, video cameras, relays, occupancy detectors. The listing of devices in each of these systems is provided for example purposes and is not to be taken in a limiting sense.

Embodiments of the present disclosure can utilize location information for purposes beyond the instantaneous modification of operation(s) of building systems and/or building system devices. For example, in some embodiments, occupancy information across a building can be determined by tracking the locations of a plurality of mobile devices. Energy savings can then be realized by providing comfortable temperature conditions and/or lighting in areas where it is most needed. In some embodiments, an occupancy heat map can be created based on the density of people at various locations in the building. In some embodiments, past locations of people and/or assets can be used to predict future energy consumption. Thus, energy expenditures can be more accurately allocated and/or anticipated.

In some embodiments, location histories can be determined and/or queried for one or more mobile devices. For instance, a security operator may access the computing device 207 to determine how long an asset spent in a particular area, what people were in that area when the asset was there, what people interacted with the asset in that area and/or in other areas. In some embodiments, the location history of a mobile device can be used to determine habits and/or productivity of one or more people.

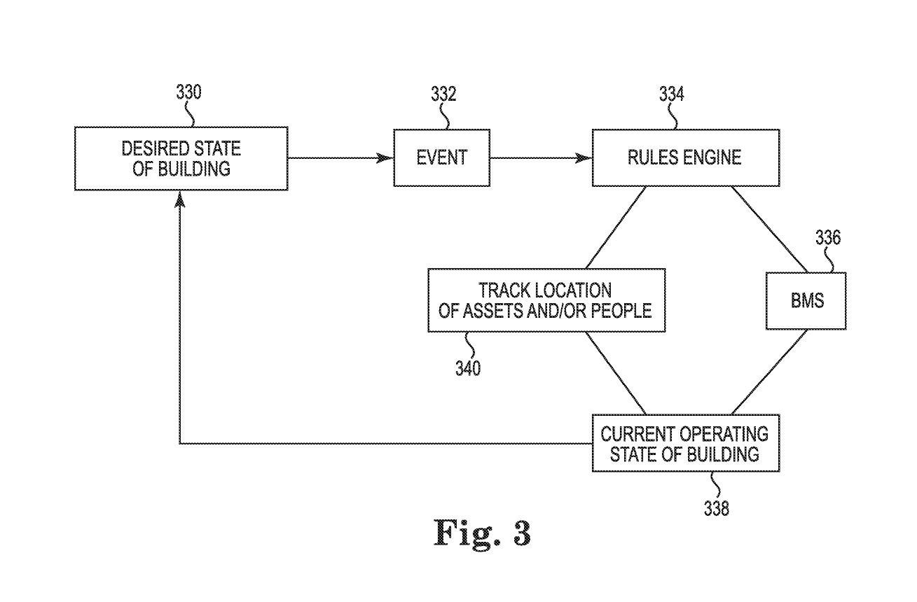

FIG. 3 illustrates a flow chart associated with building management using location information in accordance with one or more embodiments of the present disclosure. In some embodiments, location tracking may be carried out responsive to an event, alert, or alarm. For instance, at 330, a building is operating in a normal, desired state. At 332, however, an event occurs. The event 332 can be an occurrence that causes a change in the operating state of the building. For example, upon the occurrence of the event 332, the rules engine 334 can influence the operation of the BMS 336 to change the current operating state of the building 338. Depending on the current operating state 338, locations 340 may be tracked according to one or more rules in the rules engine 334.

For example, if a fire (the event 332) occurs, the operating state (or context) of the building can change from a normal or desired state 330 to a different state (fire state, emergency state, evacuation state, etc.). Such a change can be implemented by the BMS 336. According to the rules engine 334, embodiments of the present disclosure can track 340 people and/or assets within the building and guide them to appropriate (e.g., nearest, safest, etc.) exit points. The evacuation can continue with tracking until all known people and/or assets are safely outside the building. When the fire subsides, the building can be returned to a normal or desired state 330. In some embodiments, tracking may continue (e.g., for a predetermined period of time) after the event subsides or is addressed. In some embodiments, tracking may be discontinued in such cases until the next event.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A non-transitory computer-readable medium having instructions stored thereon executable by a processor to:
track a location of a mobile device in a building;
trigger an alert responsive to a determination that the tracked location of the mobile device exceeds a threshold correlation to a predetermined location rule; and
modify an operation of a building system associated with the building according to the location rule and responsive to the alert.

2. The medium of claim 1, wherein the instructions to track the location of the mobile device include instructions to track the location using a location functionality of the mobile device.

3. The medium of claim 1, wherein the tracked location of the mobile device exceeding the threshold correlation to the predetermined location rule includes the tracked location being within a particular area of the building.

4. The medium of claim 1, wherein the tracked location of the mobile device exceeding the threshold correlation to the predetermined location rule includes the tracked location being within a particular distance of another mobile device.

5. The medium of claim 1, wherein the tracked location of the mobile device exceeding the threshold correlation to the predetermined location rule includes the tracked location being within a particular distance of another mobile device for a particular period of time.

6. The medium of claim 5, wherein the tracked location of the mobile device exceeding the threshold correlation to the predetermined location rule includes the tracked location being within a particular distance of a threshold-exceeding quantity of mobile devices for a particular period of time.

7. The medium of claim 1, wherein the tracked location of the mobile device exceeding the threshold correlation to the predetermined location rule includes the tracked location being within a particular area of the building for a particular period of time.

8. The medium of claim 7, wherein the tracked location of the mobile device exceeding the threshold correlation to the predetermined location rule includes:
the tracked location being within the particular area of the building for the particular period of time; and
a quantity of additional mobile devices being within the particular area of the building exceeding a quantity threshold.

9. The medium of claim 7, wherein the tracked location of the mobile device exceeding the threshold correlation to the predetermined location rule includes the tracked location being within the particular area of the building for the particular period of time, wherein the particular area is associated with a set of location rules different than another set of location rules associated with a different area of the building.

10. The medium of claim 1, wherein the building system associated with the building includes:
a fire system;
a lighting system;
a heating, ventilation, and air conditioning (HVAC) system;
an access control system;
an elevator system;
a surveillance system;
a security system; or
a public address system.

11. The medium of claim 1, including instructions to modify an operation of another building system associated with the building according to the location rule and responsive to the alert.

12. A system for building management using location information, comprising:
a mobile device; and
a computing device associated with a building management system configured to manage security, energy usage, and personal comfort within a building;
wherein the computing device is configured to:
receive location information associated with the mobile device in the building;
store a plurality of location rules associated with the building;
trigger an alert responsive to a determination that a location of the mobile device exceeds a threshold correlation with a location rule of the plurality of location rules; and
modify an operation of a building system associated with the building according to the location rule and responsive to the alert.

13. The system of claim 12, wherein the mobile device is carried in the building by a user.

14. The system of claim 13, wherein the mobile device is a smart phone.

15. The system of claim 13, wherein the mobile device is a wearable device.

16. The system of claim 12, wherein the mobile device is not carried by a user.

17. The system of claim 16, wherein the mobile device is a tag associated with a physical object.

18. A method for building management using location information, comprising:
tracking a plurality of mobile devices in a building using a plurality of wireless beacons in the building;
triggering an alert responsive to a determination that a location of at least one of the mobile devices matches a predetermined location rule; and
modifying a respective operation of a plurality of building systems associated with the building responsive to the alert.

19. The method of claim 18, wherein the method includes tracking the plurality of mobile devices in the building responsive to a change in an operating state of the building.

20. The method of claim 19, wherein the method includes:
triggering the alert responsive to a determination that a fire alarm is activated and a respective location of each of particular subset of the plurality of mobile devices is within the building; and
communicating evacuation information via a fire system to each of the particular subset of the plurality of mobile devices.
